(19) United States
(12) Patent Application Publication
(10) Pub. No.: US 2025/0388500 A1
(43) Pub. Date: Dec. 25, 2025

(54) Refillable Buoyant Dispensing Device

(71) Applicant: Muntech Products Inc., Campbellford (CA)

(72) Inventors: Kalen Rudy MUNFORD, Campbellford (CA); Lucas Powell MUNFORD, Campbellford (CA); Lawrence Zachariah Powell MUNFORD, Campbellford (CA); Mark MUNFORD, Campbellford (CA); Steve COPELAND, Wasaga Beach (CA); Devyn SLOCUM, Orillia (CA); Nicholas TEIXEIRA, Angus (CA); Christian SHAFFER, Flower Mound, TX (US)

(73) Assignee: Muntech Products Inc., Campbellford (CA)

(21) Appl. No.: 19/247,309

(22) Filed: Jun. 24, 2025

Related U.S. Application Data
(60) Provisional application No. 63/663,258, filed on Jun. 24, 2024.

(51) Int. Cl. C02F 1/68; C02F 103/42

(52) U.S. Cl. CPC C02F 1/686; C02F 2103/42; C02F 2201/005; C02F 2209/02; C02F 2209/03; C02F 2209/40

(57) ABSTRACT

A refillable dispensing device for measurably dispensing liquid chemical treatment into a body of water, including: a vessel having a wall; a vessel opening at one end and a vessel surface at a opposite end of the vessel; a removable closure for closing the vessel opening; a metered dosing device in communication with the vessel opening and the removable closure for metered dose dispensing of liquid chemical treatment into a body of water.

The present disclosure relates to a device for delivering chemical treatment to water. The device provides accurate and reliable dosing, ensuring that the correct amount of chemical treatment is delivered into the water.

### BACKGROUND OF THE DISCLOSURE

Maintaining a chemical balance in a swimming pool or other body of water is crucial for ensuring the health and safety of users. The introduction of chemicals, such as chlorine and pH balancers, can be a complex process that requires careful monitoring and control.

Furthermore, treatment of water bodies affected by pollution, algae blooms, or invasive species is needed, including environmental remediation to aquatic ecosystem management. Additionally, targeted treatments to specific agricultural areas of a crop field or fishpond or water farm, is needed.

In conventional devices, inaccurate or inconsistent dosing can lead to ineffective treatment, resulting in inadequate removal of contaminants or unwanted byproducts as well.

### SUMMARY OF THE DISCLOSURE

As used herein, the term “liquid chemical treatment” may include, chlorine, pigmentation, supplements, herbicides, pesticides, fertilizer, food, bait, seeds, enzymes, phosphate remover, flocculant, clarifier, surfactant, detergent, bubbles, sodium bicarbonate, stain and scale remover, acids, alcohols, metals, chlorine conditioners, water adjuvants, active ingredients and the like, and combinations thereof.

As used herein, the term active ingredient and active ingredients may include various forms, including solid, liquid gel form, powder, dissolving sheet pack, dissolving sheet, liquid ingredients contained in a dissolving pouch, ready to use pre-mixed liquid, concentrated liquid, tablet, coloured dye or glow-in-the dark pigmentation, supplements, food, bait, granular products, and combinations thereof.

According to one alternative, there is provided a refillable buoyant dispensing device for measurably dispensing liquid chemical treatments into a body of water, comprising: a vessel having a wall and a vessel opening at one end and a vessel surface at an opposite end; said vessel opening for receiving a liquid into the vessel; a removable closure for closing said vessel opening, a metered dosing device, in communication with the vessel opening and said removable closure, for metered dose dispensing of the liquid chemical treatment into the body of water; wherein, during use, the metered dosing device remains below a surface level of the body of water; and wherein the vessel contains a predetermined amount of liquid chemical treatment in communication with the metered dosing device and a predetermined amount of gaseous head space above the predetermined amount of liquid chemical treatment.

In one alternative, the vessel wall further comprises a heat transfer area allowing for transfer of heat from an exterior to an interior of the vessel when ambient temperature outside the vessel is greater than the temperature inside the vessel.

In one alternative, the refillable buoyant dispensing device further comprises a liquid chemical concentration indicator.

In one alternative, the refillable buoyant dispensing device further comprises a liquid chemical volume indicator.

In one alternative, the refillable buoyant dispensing device further comprises an internal pressure sensor for monitoring internal pressure of the vessel. In another alternative, said pressure sensor sends a signal to an external control unit to adjust a dispensing rate of the liquid chemical treatment based on changes in internal pressure of said vessel.

In one alternative, the refillable buoyant dispensing device further comprises an internal temperature sensor for monitoring internal temperature of the vessel. In another alternative, said temperature sensor sends a signal to an external control unit to adjust a dispensing rate of the liquid chemical treatment based on changes in internal temperature of said vessel.

In another alternative, the refillable buoyant dispensing device may further comprise a tamper-proof locking mechanism for locking the removable closure to the vessel opening.

In another alternative, the removable closure also acts as a vessel stabilizer for setting said vessel on a surface for filling.

In another alternative, the metered dosing device further comprises a two-way valve with an outflow channel for dispensing the liquid chemical treatment into a body of water during a temperature increase and an inflow channel for receiving liquid from the body of water into the vessel during a temperature decrease.

In one alternative, the two-way valve's outflow and inflow channels are removable and replaceable to accommodate different viscosities of fluid.

In another alternative, said refillable buoyant dispensing device further comprises a two-way valve seal for sealing the metered dosing device to the vessel opening.

In one alternative, the two-way valve seal is designed with a unique mechanism that allows it to operate in both forward and reverse flow directions. This means that when the fluid pressure is higher on one side of the valve than the other, the seal will open to allow flow in the desired direction. Conversely, when the pressure equalizes or reverses, the seal will close to prevent backflow.

In one alternative, the two-way valve seal is typically made from durable materials such as stainless steel, rubber, or silicone, which providing resistance to corrosion, abrasion, and chemical degradation. In another alternative, the two-way valve seal's design may incorporate specialized features like spring-loaded or diaphragm-based mechanisms to ensure precise control over the fluid flow. These features enable the valve seal to operate reliably even in harsh environments with extreme temperatures, pressures, or chemicals.

In another alternative, the two-way valve is replaced by two one-way valves with a first one-way valve allowing liquid to flow out of the vessel at a temperature increase as discussed herein, and a second one-way valve allowing liquid to flow into the vessel at a temperature decrease as discussed herein.

In one alternative, the two one-way valves are proximate one another.

In another alternative, the two one-way valves are distant one another.

In one alternative, the refillable buoyant dispensing device may be blow-moulded and/or injection-moulded and made from a material selected from the group consisting of ultra-violet (UV) enhanced high-density polyethylene (HDPE) plastic, UV-enhanced polypropylene plastic, and combinations thereof.

In another alternative, the vessel may have a flattened surface for keeping the refillable buoyant dispensing device stationary while filling the vessel with a liquid, a solid, and combinations thereof, preferably via the vessel opening.

In another alternative, the flattened surface is a beveled surface acting as a lens to increase the temperature inside the vessel.

In another alternative, the vessel's surface acts as a lens as described herein.

Focusing the intense rays of sunlight on the vessel increases the temperature inside the vessel. As the lens focuses the sun's rays, the heat generated by the concentrated light is transferred into the vessel, causing its internal temperature to rise.

The refillable buoyant dispensing device's reliance on natural sunlight means that no external power source or fuel is required to increase and/or decrease the internal temperature of the vessel, making it a sustainable and environmentally friendly option.

In one alternative, the vessel comprises a liquid phase and a gaseous phase being in the form of a gaseous head space creating positive/negative pressure determined by ambient temperature variation, allowing for consistent dispensing of the liquid chemical treatment into the body of water.

In one alternative, a 10° C. ambient temperature increase, allows the refillable buoyant dispensing device to dispense the liquid chemical treatment into the body of water.

In one alternative, a 10° C. ambient temperature decrease, allows the refillable buoyant dispensing device to receive liquid from the body of water.

Not wanting to be bound by theory, the basis for the calculation is taken from the volumetric thermal expansion coefficient of air=0.0034/° C. The headspace calculation is based on air, but an alternative gas or combination of gases may also be used in the place of air having a different thermal expansion coefficient.

In one alternative, there is provided at least one fill indicator, preferably a fill line, for indicating the required amount of gas inside the vessel once fluid is introduced into the vessel to facilitate gas pressure transfer.

In one alternative, the vessel comprises a plurality of fill indicators, preferably a plurality of fill level lines, providing time period indicators, such as, but not limited to, 30 days until refill, 15 days until refill, 5 days until refill, refill time.

In one alternative, the vessel may be of any shape buoyant on a body of water and delivering liquid treatment to a body of water.

In another alternative, said vessel comprises a concentrated liquid chemical bladder separate from a body of water liquid bladder, wherein the concentrated liquid chemical bladder is connected to a first one-way valve allowing liquid to flow out of the vessel and the body of water liquid bladder is connected to a second one-way valve allowing flow from the body of water into the vessel.

In one alternative, the liquid chemical is coloured, preferably by adding a coloured dye or glow-in-the-dark pigmentation to the internal liquid chemical. In this alternative, the coloured product inside the vessel is visible to the user and a change in colour may indicate a depletion of effective strength of the liquid chemical indicating the vessel needs to be refilled with a liquid chemical of full strength.

The refillable buoyant dispensing device's ability to measure and control its dispensing process allows for accurate application of the chemical treatments. This precision is particularly important when working with sensitive ecosystems or delicate aquatic systems, where the wrong amount or timing of treatment can have unintended consequences. The refillable buoyant dispensing device's refillable design also reduces waste and minimizes the need for frequent replacements.

The buoyant nature of the refillable buoyant dispensing device enables it to remain afloat on the surface of the water, allowing for easy deployment and retrieval. This feature is particularly useful in areas with strong currents or turbulent waters, where traditional dispensing methods may not be effective. The refillable buoyant dispensing device's buoyancy also allows it to maintain its position and continue dispensing treatments even in choppy or rough conditions.

The technology's potential applications are vast, from environmental remediation to aquatic ecosystem management. It could be used to treat water bodies affected by pollution, algae blooms, or invasive species. Additionally, the refillable buoyant dispensing device could be employed in agriculture to deliver targeted treatments to specific areas of a crop field or pond. With its versatility and precision, this innovative technology has the potential to make a significant impact in various industries and environmental settings.

In this specific application, according to one alternative, the vessel is divided into two distinct phases: a liquid phase and a gas phase.

As the temperature within the vessel increases, the gas phase expands in volume, causing the pressure to rise accordingly. This increase in pressure exerts pressure on the liquid leading to the release of a predetermined amount of the liquid phase through, in one alternative, two-way valve. The amount of liquid released through the two-way valve is dependent on the equalization of the pressure within the vessel.

Conversely, as the temperature within the vessel decreases, the gas phase contracts in volume, causing the pressure to decrease. This reduction in pressure allows liquid from outside the vessel to enter through the same two-way valve, replenishing the liquid phase.

The thermal expansion vessel has numerous potential applications across various industries as discussed herein.

Although not wanting to be bound by theory, the fundamental principle of thermal energy conversion, as described by Charles' Law, is applicable to the present disclosure. This law states that the volume of an ideal gas is directly proportional to the temperature it is heated or cooled to, provided that the pressure remains constant. In other words, as the temperature of a gas increases, its volume also expands accordingly. Conversely, when the temperature decreases, the volume contracts. In the context of the present disclosure, the vessel contains both a liquid phase and an air phase, and as the temperature of the air phase changes, the pressure of the gas also varys accordingly. This can result in changes to the total pressure exerted by the air phase, which may in turn affect the behaviour of the liquid phase. For instance, an increase in temperature of a gas could lead to an increase in the overall gas pressure within the vessel and cause the liquid to move through the two-way valve.

In another alternative, the removable closure further comprises a threaded valve cap with a predetermined mass that allows the threaded valve cap to consistently direct the threaded valve cap portion of the refillable buoyant dispensing device under water, allowing for effluent flow to the body of water and influent flow into the vessel.

According to yet another alternative, there is provided a method of treating a body of water comprising the use of the refillable buoyant dispensing device described herein comprising placing the refillable buoyant dispensing device on a surface of a body of water and allowing it to dispense liquid chemical treatment based on internal air temperature changes.

According to yet another alternative, there is provided a refillable dispensing device for measurably dispensing liquid chemical treatment into a body of water, comprising: a vessel having a flexible wall and a vessel opening at one end and a vessel surface at a opposite end of said vessel; said vessel opening for receiving a liquid into said vessel; a removable closure for closing said vessel opening, a metered dosing device in communication with said vessel opening and said removable closure, for metered dose dispensing of said liquid chemical treatment into said body of water; wherein in use, said refillable dispensing device remains below a surface level of said body of water; wherein in use, said flexible vessel contains a predetermined amount of liquid chemical treatment, in communication with said metered dosing device, wherein in use when under a surface of said body of water, hydrostatic pressure of said body of water acts upon the flexible vessel causing a predetermined amount of liquid chemical to pass through the metered dosing device into said body of water; wherein when said vessel moves up the body of water, the hydrostatic pressure is reduced on the vessel causing water from said body of water to enter said vessel.

In one alternative, the vessel having a flexible wall my be constructed of the following materials: Low Density Polyethylene, High Density Polyethylene, Polyvinyl Chloride Silicone, Rubber, Thermoplastic elastomer, thermoplastic rubber, polypropylene, variations thereof and combinations thereof.

In another alternative, the vessel with a flexible wall may also be achieved by having a vessel with thinner wall portions of a vessel made with rigid materials including rigid plastics and combinations thereof.

In another alternative, the refillable dispensing device further comprises a gas producing element within the device for increasing internal pressure of the device.

According to yet another alternative, the refillable dispensing device comprises two vessels matingly attached to each other, each of said two vessels having a vessel opening, wherein each of said two vessel openings are adjacent to each other, wherein each of said two vessels contains a liquid selected from the group consisting of: i) different from each other; ii) same as each other.

In one alternative, each of the two vessels are matingly attached to each other via at least one of the following:
a. a friction fit;
b. each of said two vessels comprise a male portion and a female portion, wherein the male portion of one of said two vessels fits in the female portion of the other of said two vessels and the male portion of the other of said two vessels fits in the female portion of the one of said two vessels;
c. a two vessel locking collar; and combinations thereof.

In one alternative, each of said two vessels have a metered dosing device.

In one alternative, the two-vessel locking collar is proximate the vessel opening.

According to yet another alternative, there is provided a refillable dispensing device further comprising a detachable media dispenser (or an erosion feeder) attached to an outside surface of said vessel, said detachable media dispenser comprising:
a. A body having a closed end and an open end; said closed end having at least one connector, preferably a plurality of spaced-apart connectors, for connecting to said outside surface of said vessel;
b. A cap for matingly engagement with said open end of said body;
c. Said body further comprises a containment area for containing said media;
   wherein said body further comprises at least one opening along a side thereof for water and media passage from the containment area to the body of water and from the body of water to the containment area; wherein said cap further comprises at least one opening along a side thereof for water and media passage from the containment area to the body of water and from the body of water to the containment area; wherein said cap is adjustable from a first position to a second position, wherein in a first position the at least one opening of said body is in alignment with the at least one opening of said cap, to a second position wherein the at least one opening of said body is not in alignment with the at least one opening of said cap, regulating the flow of water and media from the containment area to the body of water and from the body of water to the containment area; wherein said at least one connector for connecting to said outside surface of said vessel connects said detachable media dispenser such that the closed end of the body of the detachable media dispenser is distant said metered dosing device allowing for access to the removable closure without the need to detach the detachable media dispenser from the vessel.

In one alternative, said media of said detachable media dispenser comprises one or more water treatment agents selected from the group consisting of halogen-based sanitizers (including but not limited to chlorine and bromine), pH adjusters (including sodium carbonate, sodium bicarbonate, sodium bisulfate), hardness increasers (such as calcium chloride), stabilizers (such as cyanuric acid), alkalinity increasers, oxidizers (including calcium hypochlorite and dipotassium monopersulfate), flocculants, scale inhibitors, enzymes, phosphate removers, mineral-based sanitizers (including silver and copper ions), algaecides, clarifiers, stain and scale preventatives, sequestering agents, surfactant blends, specialty seasonal formulations (including but not limited to winterizing or startup blends), fragrance compounds, water softening agents, biological control agents, effervescent agents, dispersing agents, lanthanum, lanthanide, aluminum, alum, borates, activated carbon, and combination thereof.

In one alternative, said media is in the form of a solid, liquid, powder, compressed tablet, granule, encapsulated media including a dissolving pouch, and combinations thereof suitable for controlled erosion or dissolution within the dispensing device.

In one alternative, concentration levels of the one or more water treatment agents can range depending on what the agent is/agents are from under 1% to 100%. One example of a chlorine agent and a mineral sanitizer can be 100% trichloro-s-triazinetrione. Another example is mineral sanitizers under 1% with “other ingredients” making up the rest.

In one alternative, said body of said refillable dispensing device comprises a plurality of spaced apart openings along said side, and said cap comprises a plurality of spaced apart openings along said side.

In one alternative, said refillable dispensing device is made from a material selected from an ultra-violet (UV) activated colour changing resin such that when indoors, said fill indicator(s), fill line(s), fill level line(s) and visible indoors when refilling the device, and not visible outdoors and when in water.

In one alternative, there is provided a method of treating a body of water with the refillable buoyant dispensing device comprising two vessels, comprising:
placing the refillable buoyant dispensing device filled with a liquid chemical treatment on a surface of a body of water; and
allowing the refillable buoyant dispensing device to dispense into said body of water liquid chemical treatment based on internal air temperature changes.

In one alternative, there is provided a method of treating a body of water with the refillable buoyant dispensing device further comprising the detachable media dispenser, comprising:
placing the refillable buoyant dispensing device filled with a liquid chemical treatment and detachable media dispenser filled with a media on a surface of a body of water; and
allowing the refillable buoyant dispensing device and detachable media dispenser to dispense into said body of water liquid chemical treatment from the refillable buoyant dispensing device based on internal air temperature changes and media from the detachable media dispenser based on dissolution.

In addition, the refillable buoyant dispensing device is inexpensive both to produce and for the consumer to purchase in comparison to plumbed dispensers. The device may be used in residential settings, such as pools or hot tubs, and allows for consistent dispensing of specialty treatment chemicals into the body of water.

### BRIEF DESCRIPTION OF THE DRAWINGS

FIG. 1 is a cross-sectional view of the refillable buoyant dispensing device, showing its various components, according to one alternative.

FIG. 2 is a cross-sectional view of the refillable buoyant dispensing device in equilibrium, according to one alternative.

FIG. 3 is a cross-sectional view of the refillable buoyant dispensing device when delivering chemical treatment to a body of water, according to one alternative.

FIG. 4 is a cross-sectional view of the refillable buoyant dispensing device when receiving water from a body of water, according to one alternative.

FIG. 5 provides the refillable buoyant dispensing device when in a refillable position, according to one alternative.

FIG. 6 is a cross-sectional view of the refillable buoyant dispensing device, showing its various components, according to another alternative.

FIG. 7 is a cross-sectional view of the refillable buoyant dispensing device, showing its various components, according to another alternative.

FIG. 8A is a planar view of the removable vessel opening closure, according to one alternative.

FIG. 8B is a planar view of the removable vessel opening closure, according to one alternative.

FIG. 9 is a cross-sectional view of a refillable buoyant dispensing device, according to another alternative.

FIG. 10 is a cross-sectional view of the refillable buoyant dispensing device of FIG. 9.

FIG. 11 is a cross-sectional view of the refillable buoyant dispensing device of FIG. 9.

FIG. 12 is a perspective view of a refillable buoyant dispensing device according to another alternative.

FIG. 13 is a side cut-away view of the refillable buoyant dispensing device of FIG. 12.

FIG. 14 is a perspective view of a media dispenser, according to one alternative.

FIG. 14A is a perspective view of a cap of the media dispenser of FIG. 14.

FIG. 15 is a view of a refillable buoyant dispensing device indoors and outdoors, according to another alternative.

FIG. 16 is a top cut-away view of the refillable buoyant dispensing device of FIGS. 12 and 13.

FIG. 17A and 17B depict the media dispenser cap in a first position and a second position, respectively.

FIG. 18A depicts the refillable buoyant dispensing device connected to a submersible cleaning robot.

FIG. 18B depicts the refillable buoyant dispensing device inside a submersible cleaning robot.

### DETAILED DESCRIPTION OF THE DISCLOSURE

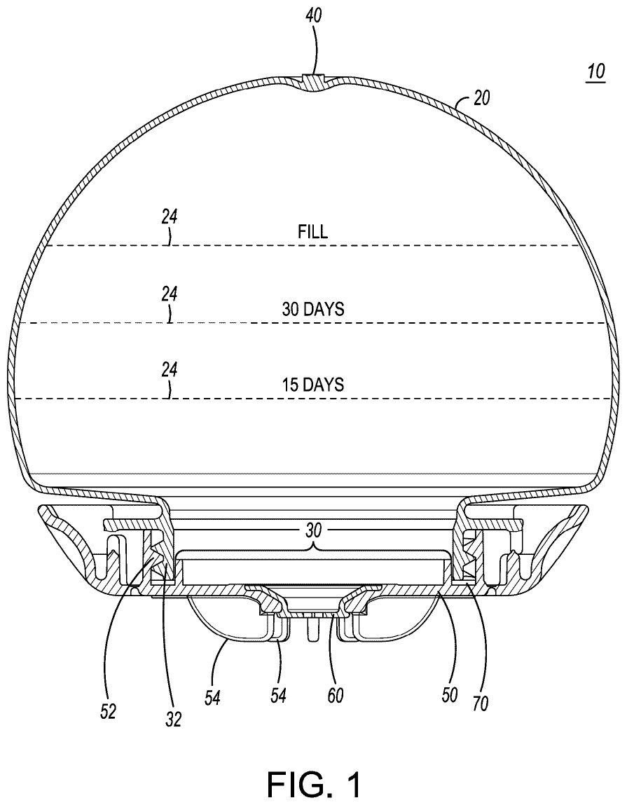

Referring now to FIG. 1, there is depicted a refillable buoyant dispensing device 10, consisting of a vessel 20, a vessel opening 30 at one end of the vessel 20, and a vessel surface 40 at another end of the vessel 20. The vessel opening 30 comprises a male threaded portion 32 to accommodate a removable vessel opening closure 50, wherein the removable vessel opening closure 50 comprises a female threaded portion 52 to receive the male threaded portion 32 of the vessel opening 30. In one alternative, centrally located on the removable vessel opening closure 50 is a two-way valve 60 sitting in a two-way valve seat 62. Between the male threaded portion 32 and an interior of the removable vessel opening closure 50 is a valve seal 70 to maintain a waterproof seal when the removable vessel opening closure 50 is secured onto the vessel opening 30, wherein the metered dosing device serves as a closure to close the vessel opening 30 of the vessel 20.

The removable vessel opening closure 50 further comprises a plurality of spaced-apart support flanges 54. The removable vessel opening closure 50 further serves as a ballast ensuring the removable vessel opening closure 50 is submerged below a water level when the refillable buoyant dispensing device 10 is in a body of water.

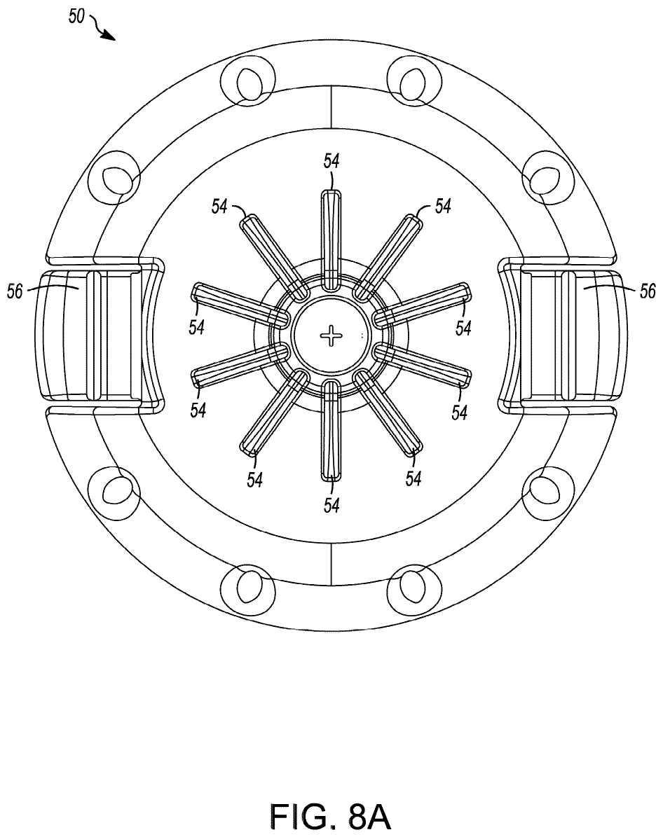

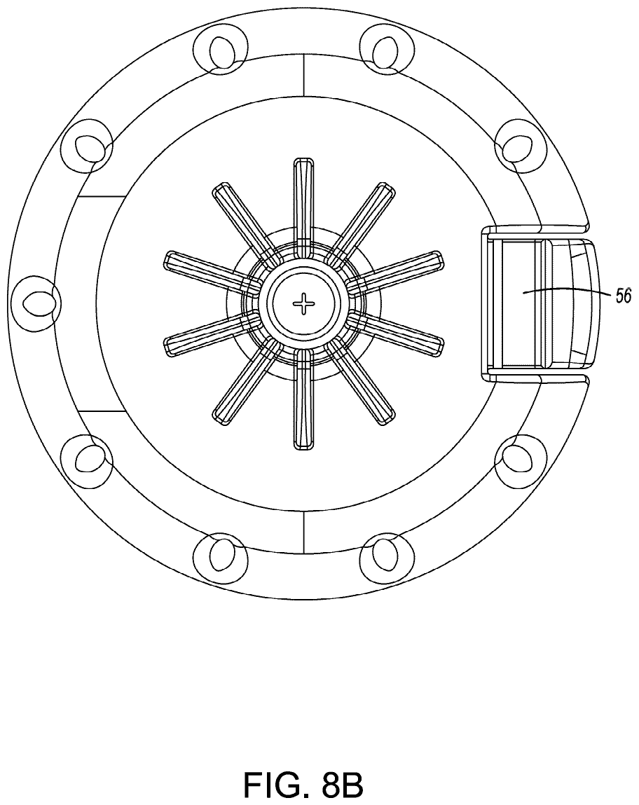

The removable vessel opening closure 50 further comprises tamper proof elements to mitigate tampering and/or removal of the removable vessel opening closure 50 by unauthorized individuals and children. In one alternative, the removable vessel opening closure 50, as best seen in FIG. 8A, the removable vessel opening closure 50 has two depressible tabs 56 along the outside perimeter of the removable vessel opening closure 50. Both of the two depressible tabs 56 are required to be actuated, by depressing the two depressible tabs 56, in order for the removable vessel opening closure 50 to be unthreaded from the vessel opening 30. The plurality of spaced-apart support flanges 54 also serve to mitigate drinking the contents of the vessel 20. FIG. 8B depicts a single depressible tab 56 as a tamper proof element.

The refillable buoyant dispensing device further comprises a plurality of visual fill (or volume or concentration) indicators 24 (see FIG. 1) on the surface thereof providing indications for refill time period, and in another alternative providing refill time based on number of cycles of chemical volume and/or concentration.

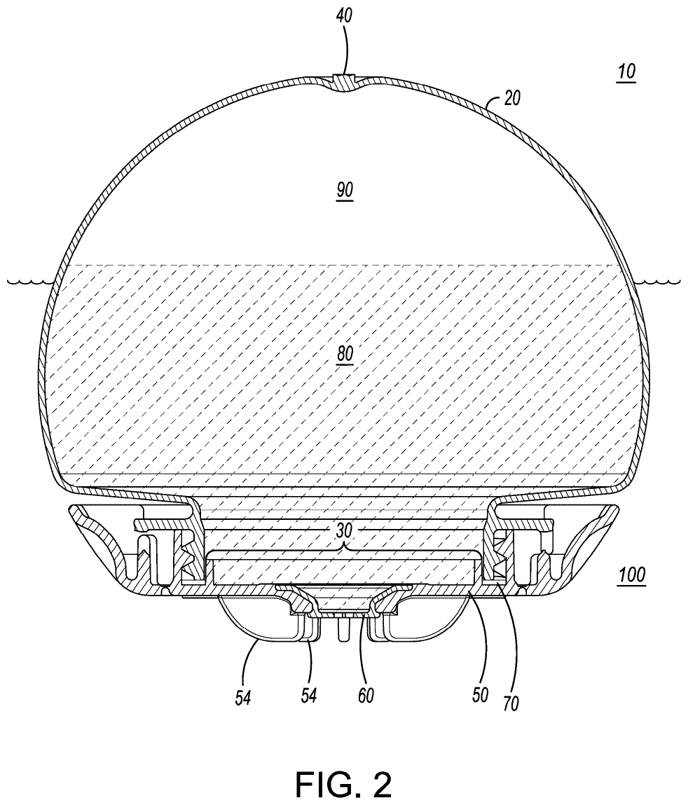

Referring now to FIG. 2, there is provided the refillable buoyant dispensing device 10 of FIG. 1 with a liquid chemical treatment 80 contained within the vessel 20, and a gaseous headspace 90 within the vessel 20. In FIG. 2, the refillable buoyant dispensing device 10 is floating in a body of water 100. In this state of equilibrium, the two-way valve 60 is closed.

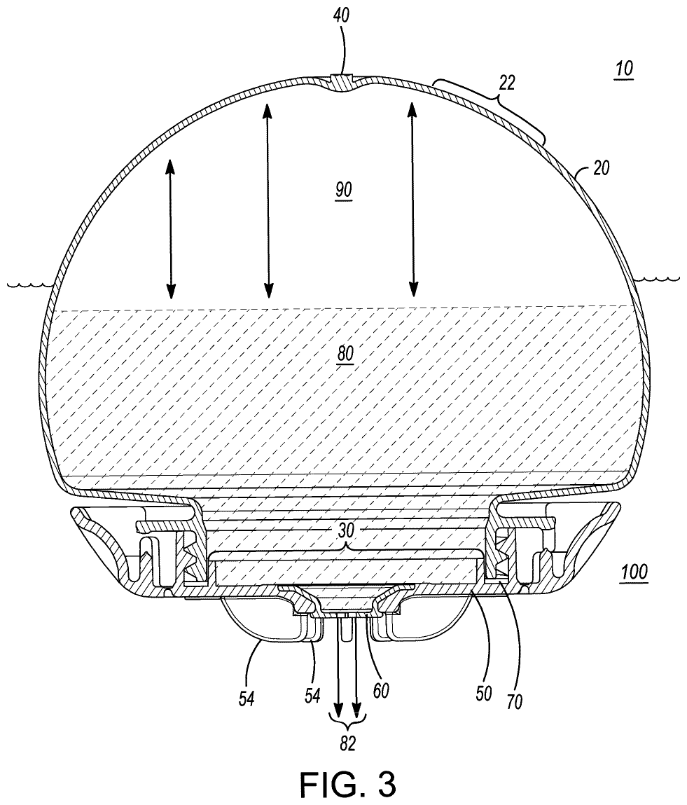

Referring now to FIG. 3, the daylight hitting the surface of the vessel 20, in one instance a heat transfer surface 22, increases the internal temperature of the vessel 20 resulting in a pressure increase of the gaseous headspace 90 and increasing the volume of the gaseous headspace 90, urging the liquid chemical treatment 80 through the two-way valve 60 and into the body of water 100 forming an outside mixture 82. The two-way valve 60 may be designed to allow for opening thereof dependent on the desired conditions such as volume allowed to pass through dependent on pressure increase within the vessel 20.

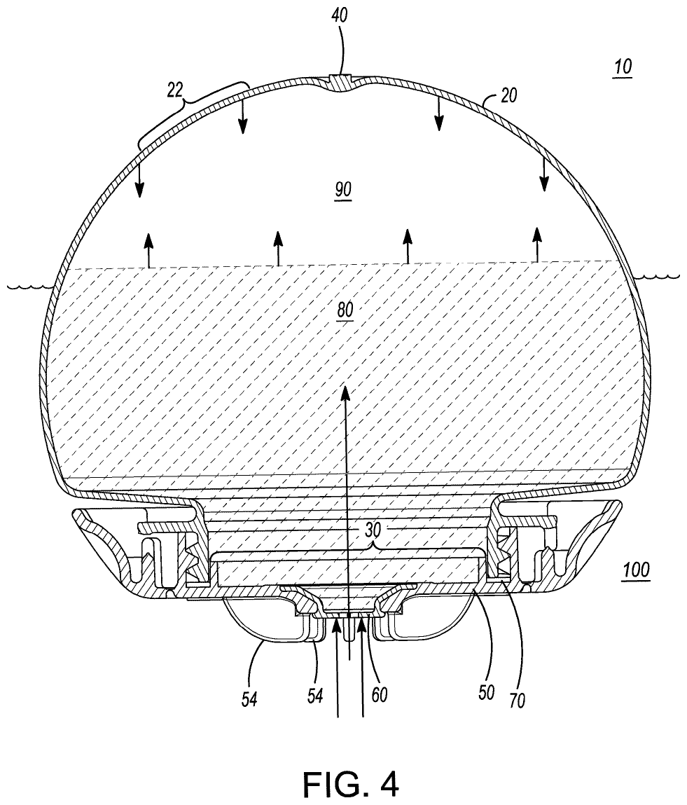

Referring now to FIG. 4, a decrease in temperature outside the surface of the vessel 20, in one instance a heat transfer surface 22, decreases the internal temperature of the vessel 20 resulting in a pressure decrease of the gaseous headspace 90 and decreasing the volume of the gaseous headspace 90, urging water from the body of water 100 to enter through the two-way valve 60 and mixing with the liquid chemical treatment 80 in the vessel 20 causing a reduction in concentration of the liquid chemical treatment 80. The two-way valve 60 may be designed to allow for opening thereof dependent on the desired conditions such as volume allowed to pass through dependent on pressure decrease within the vessel 20.

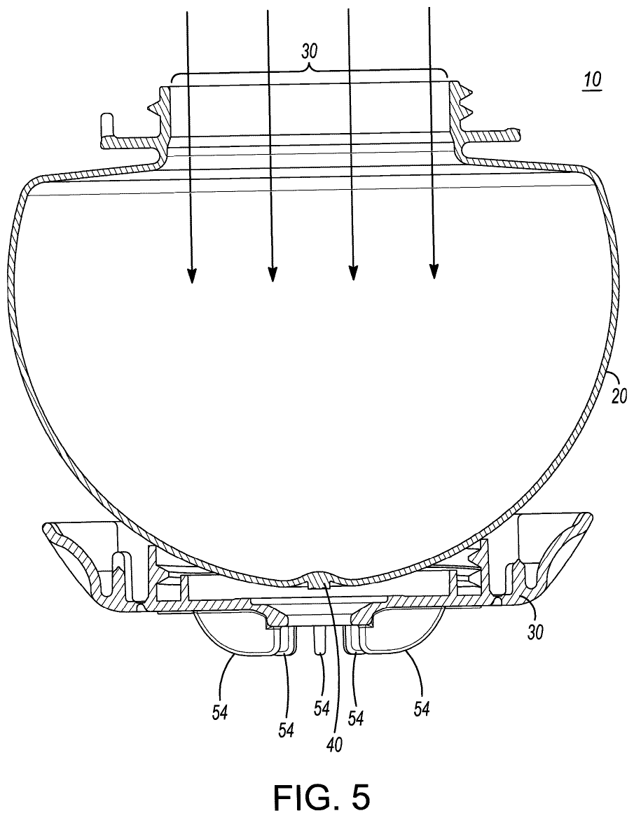

Referring now to FIG. 5, the refillable buoyant dispensing device 10 is shown when refilling is required. The vessel surface end 40 of the vessel 20 sits securely within the removable vessel opening closure 50 and the plurality of spaced-apart support flanges 54 allow for a secure and stable positioning of the vessel 20 on a surface such that the user may introduce content into the vessel 20 through vessel opening 30.

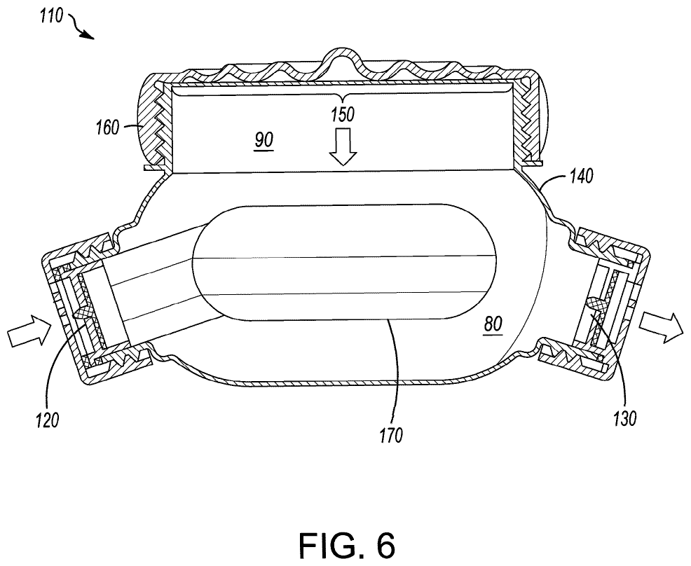

Referring now to FIG. 6, there is provided an alternative to the refillable buoyant dispensing device 110, with a dedicated influent one-way valve 120 and a dedicated effluent one-way valve 130. The alternative refillable buoyant dispensing device 110, includes a vessel 140 with a vessel opening 150 and a removable vessel opening closure 160. The refillable buoyant dispensing device 110 is biased in this alternative to ensure the influent one-way valve 120 and effluent one-way valve 130 are below the water surface. In this alternative the liquid chemical treatment 80 within the vessel 140 is separated from any influent from the body of water 100 by a flexible bladder 170 ensuring the liquid chemical treatment 80 remains undiluted by any influent from the body of water 100 mixing with the liquid chemical treatment 80. In this alternative, as the temperature increases inside the vessel 140, the gaseous headspace 90 will experience an increase in temperature and pressure urging the liquid chemical treatment 80 through the effluent one-way valve 130. Similarly, a decrease in temperature will cause a decrease in pressure of the gaseous headspace 90 urging water from the body of water 100 to enter the vessel 140 through the influent one-way valve 120. The removable vessel opening closure 160 is threaded similar to the earlier device ensuring a water-tight seal between the removable vessel opening closure 160 and vessel opening 150.

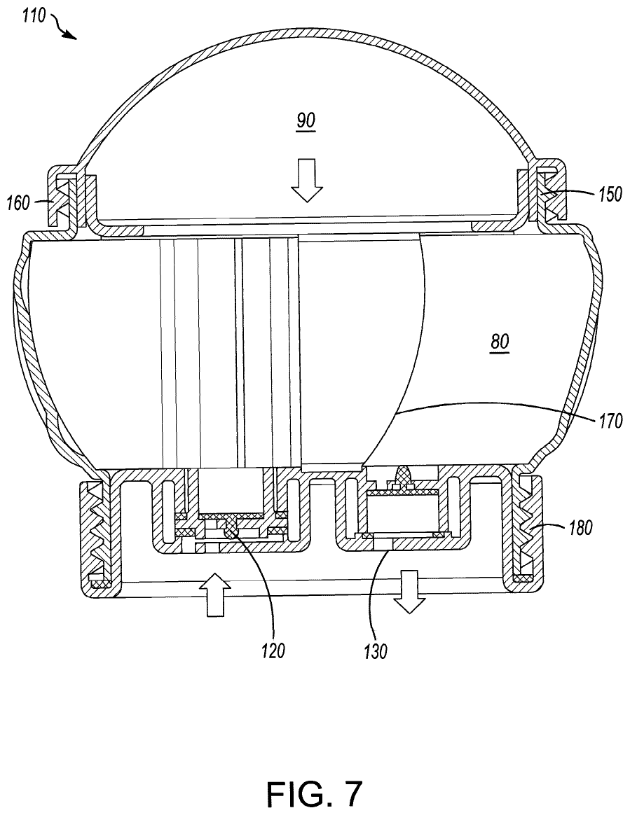

Referring now to FIG. 7, there is depicted a further alternative to the refillable buoyant dispensing device 110. Herein the device functions as that of refillable buoyant dispensing device 110. A difference is the dedicated influent one-way valve 120 and a dedicated effluent one-way valve 130 are proximate each other. Furthermore, the refillable buoyant dispensing device 110 end with the dedicated influent one-way valve 120 and a dedicated effluent one-way valve 130 further comprises a base component 180 to allow for the stable positioning of the refillable buoyant dispensing device 110 when refilling is required.

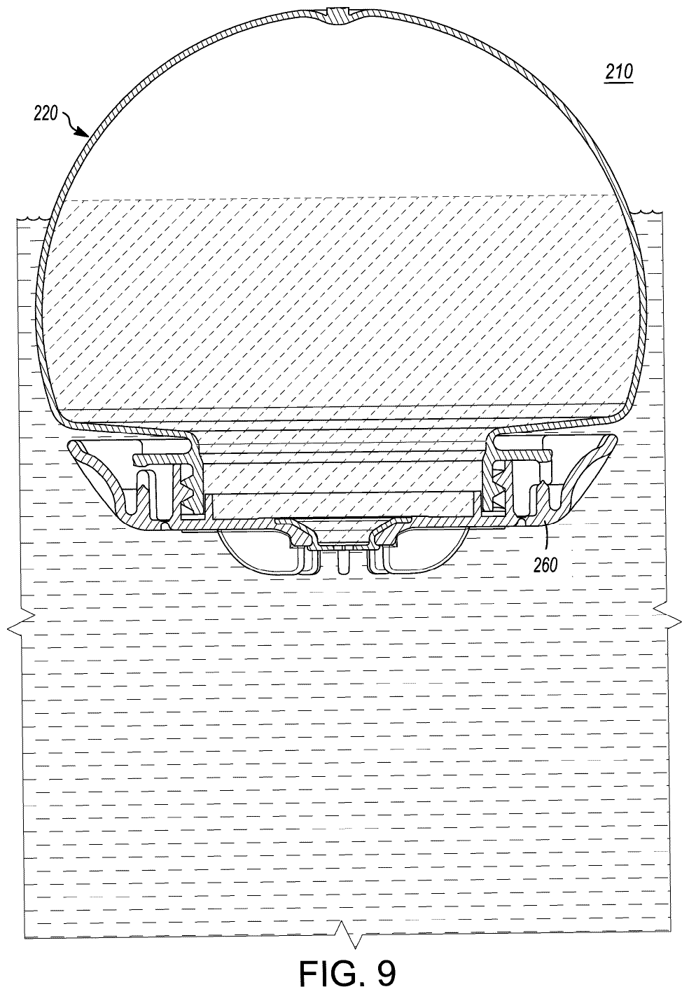

Referring now to FIG. 9, there is provided a further alternative to the refillable buoyant dispensing device 210 for submersible use, wherein the vessel 220 comprises a flexible material which upon entering a body of water, the outside of the vessel 220 exposed to water pressure (i.e. hydrostatic pressure) causing the vessel 220 to flex inwards toward a removable vessel opening closure 260 releasing the contents of the vessel 220 into the body of water.

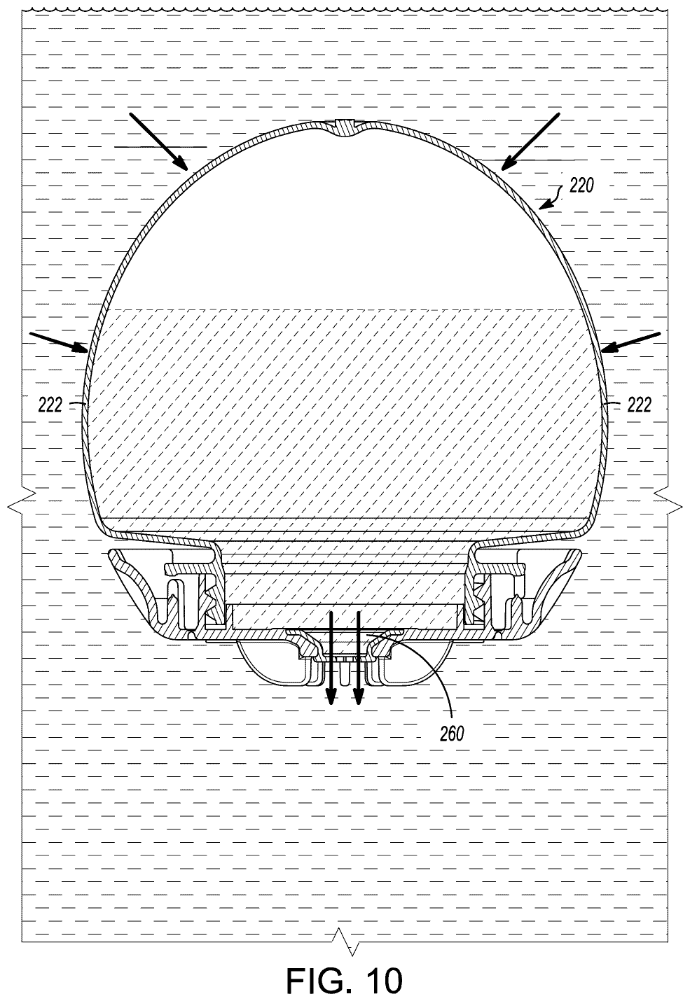

Referring now to FIG. 10, there is provided the refillable buoyant dispensing device 210 for submersible use at 5 feet below water level, wherein the vessel 220 comprises a flexible material and a rigid material 222, which upon entering a body of water, the outside of the vessel 220 exposed to water pressure causing the flexible material of the vessel 220 to flex inwards toward a removable vessel opening closure 260 releasing the contents of the vessel 220 into the body of water. In this alternative, the rigid material 222 is proximate the removable vessel opening closure 260.

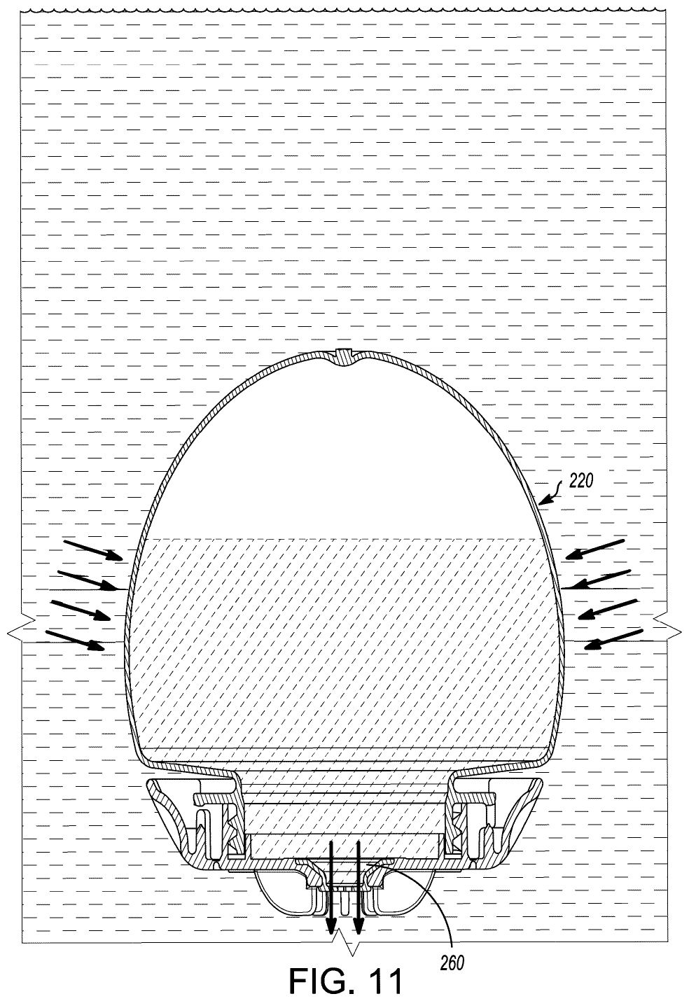

Referring now to FIG. 11, the refillable buoyant dispensing device 210 is submerged deeper (i.e. 10 feet below water level) in the water than that shown in FIG. 10. The refillable buoyant dispensing device 210 is subjected to greater hydrostatic pressure causing the vessel 220 to further flex inward causing further release of the contents into the body of water.

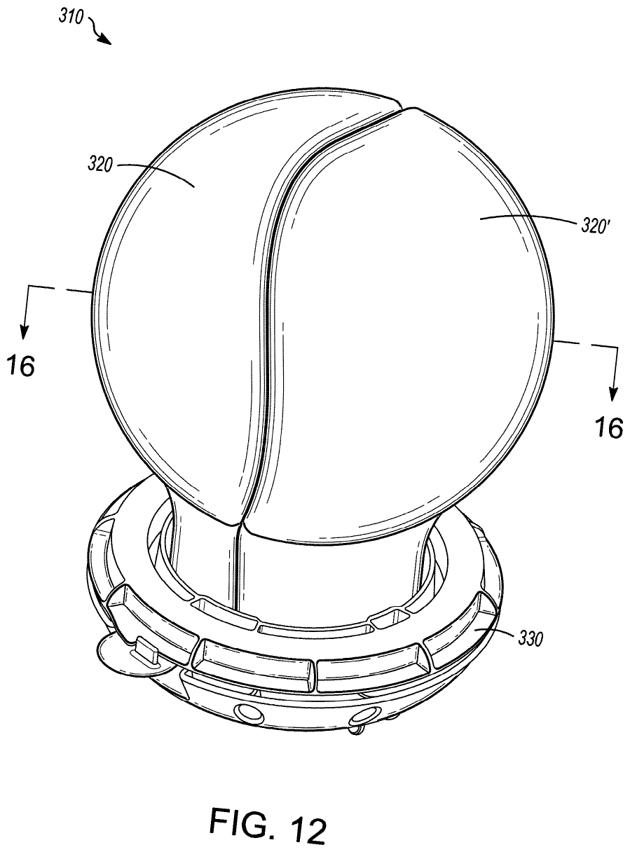

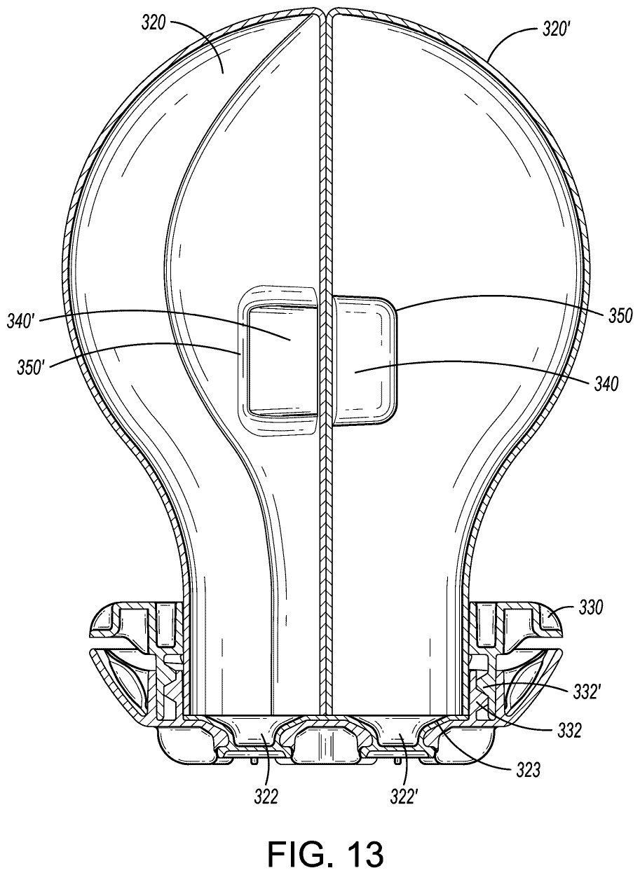

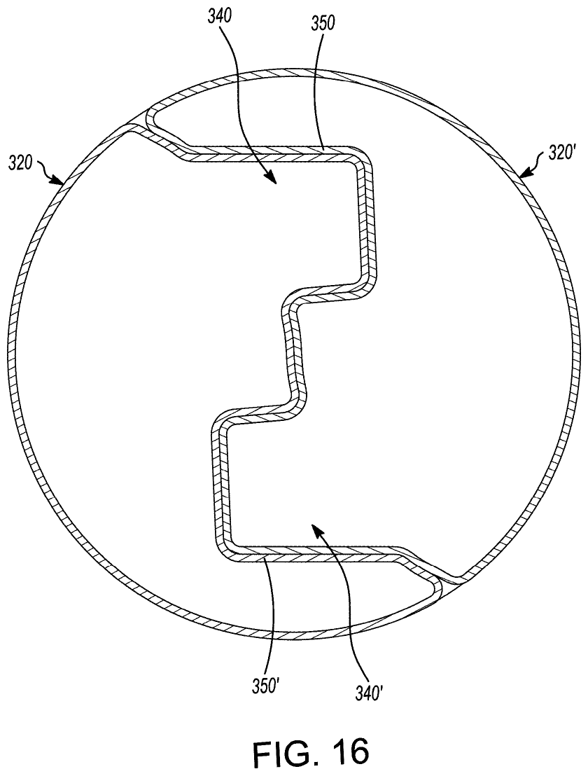

Referring now to FIG. 12, there is depicted a refillable buoyant dispensing device 310 made of two matingly engageable vessels 320, 320′, secured at the opening end with a locking collar 330. Referring now to FIGS. 13 and 16, vessel 320 and 320′ are mated to each other via a male portion 340 of vessel 320 fitting into a female portion 350 of vessel 320′. Similarly, male portion 340′ of vessel 320′ fits into female portion 350′ of vessel 320 (see FIG. 13) for a friction fit. The connected vessels 320, 320′ form at the vessel opening end a locking collar thread 332 around the perimeter of the opening end, to receive the locking collar 330 having a complementary thread 332′ to engage the locking collar thread 332. The connected vessels 320. 320′ are each fitted with a two-way valve 322, 322′ respectively for the purpose as discussed above. The locking collar 330 is placed overtop, in one alternative a two-way valve 322, 322′ sealing layer 323 providing a watertight seal and then threaded onto the connected vessels 320, 320′.

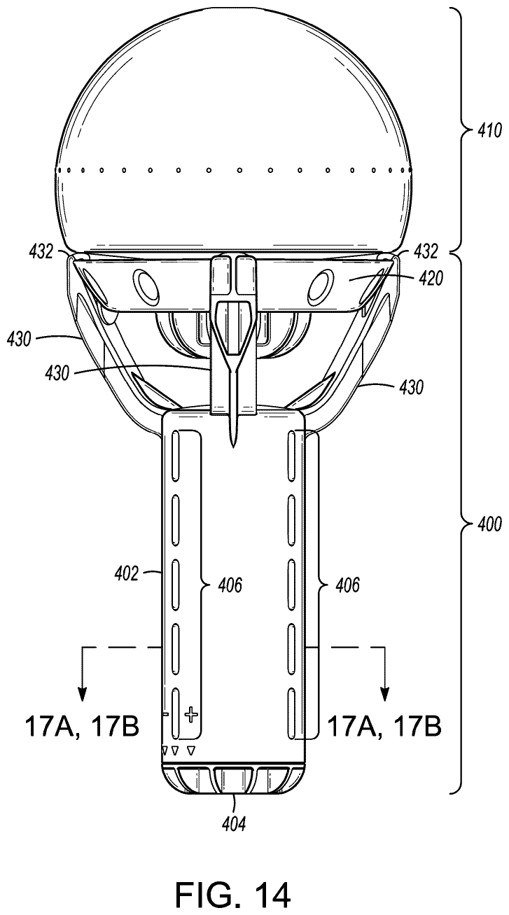

Referring now to FIG. 14, there is depicted a detachable media dispenser 400 connected to a refillable buoyant dispensing device 410. In this alternative, the detachable media dispenser 400 is connected to the refillable buoyant dispensing device 410 at the perimeter of the removable vessel opening closure 420 by three spaced-apart connectors 430. The three spaced-apart connectors 430 may be clipped on to place, or any other locking mechanism, by a clip 432 onto the edge of the removable vessel opening closure 420. Clip 432 may be resiliently biased towards the edge of the removable vessel open closure 420. The detachable media dispenser has a main cylindrical body 402 extending from one end of the three spaced-apart connectors 430 distant the refillable buoyant dispensing device 410 and terminating at an open end closed with a removable cap 404. Referring to FIG. 14A, the inside of the removable cap 404 and/or the inside of the main cylindrical body 402 may have a containment area 407 for containing media to be dispensed. The main cylindrical body 402 includes a series of spaced-apart slots 406 along the side wall of the main cylindrical body 402. The removable cap 404 includes a series of spaced-apart cap slots 408 complementary to the spaced-apart slots 406 of the main cylindrical body 402. The removable cap 404 may be inserted snugly into the main cylindrical body 402 and rotated in place from a first position where the spaced-apart cap slots 408 are in alignment with the spaced-apart slots 406, to a second position where the spaced-apart cap slots 408 are not in alignment with the spaced-apart slots 406. The rotation of the removable cap 404 allows for control of flow of water and media to and from the detachable media dispenser 400. The removable cap 404 may be rotated in place by a cap rib 405 kept in place by a cap rib node 403 on the inside of the main cylindrical body 402.

The media dispenser 400 is connected to the refillable buoyant dispensing device 410 such that access to the removable vessel opening closure 420 is not inhibited.

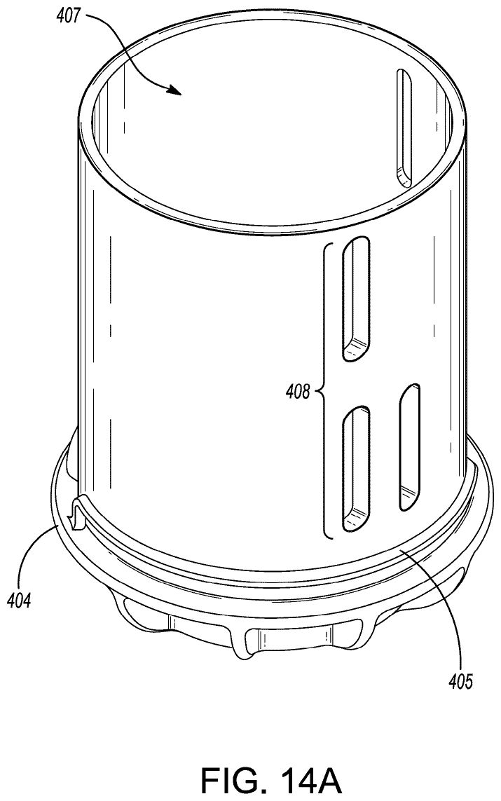

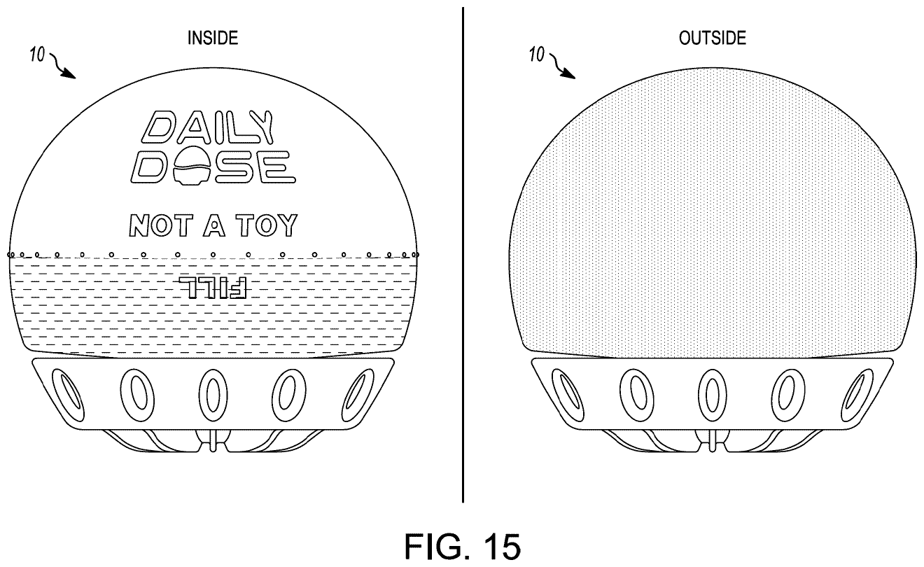

Referring now to FIG. 15, there is depicted a refillable buoyant dispensing device 10 made of from a material selected from an ultra-violet (UV) activated colour changing resin such that when indoors, said fill indicator(s), fill line(s), fill level line(s) are visible when refilling the device (left side view), and not visible outdoors and when in water (right side view).

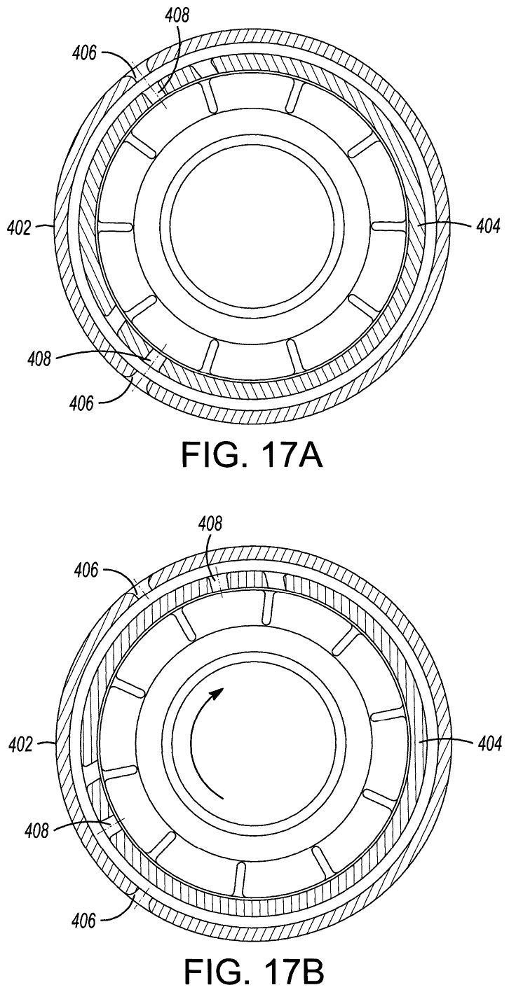

Referring now to FIG. 17A, there is depicted the spaced-apart main cylindrical body slots 406 of the maid cylindrical body 402 in alignment with the spaced-apart cap slots 408 of removable cap 404 allowing for free flow of water and media to and from the detachable media dispenser.

Referring now to FIG. 17B, there is depicted the spaced-apart main cylindrical body slots 406 of the main cylindrical body 402 out of alignment with the spaced-apart cap slots 408 of removable cap 404 for controlling the flow of water and media to and from the detachable media dispenser.

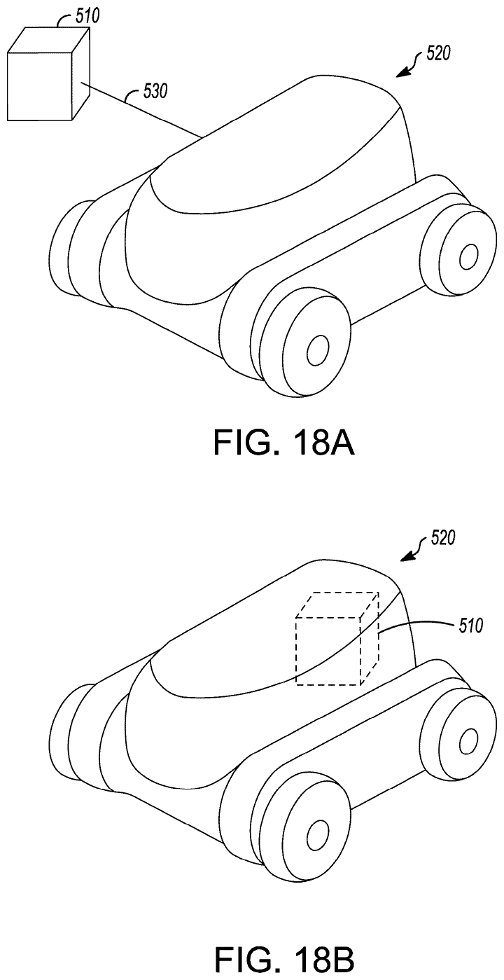

Referring now to FIG. 18A, there is depicted a refillable buoyant dispensing device 510 connected to a submersible cleaning robot 520. The refillable dispensing device 510 may be physically connected to the submersible cleaning robot 520 by a connector line 530 or the like, or may be connected wirelessly with wireless connection systems known in the art.

Referring now to FIG. 18B, there is depicted the refillable buoyant dispensing device 510 inside a submersible cleaning robot 520.

The submersible versions described above in FIGS. 9, 10 and 11 may be secured onto and/or into submersible robotic cleaning devices, manual cleaning devices and the like to allow a user to treat the body of water while cleaning the body of water. In one example, the submersible versions may be secured to the end of a brush or skimmer net such that when the brush or skimmer net is submerged into the body of water to scrub underwater surfaces or collect debris such as leaves and the like, the submersible version will be under pressure by the body of water and will release the desired content from the flexible vessel.

The refillable buoyant dispensing device provides accurate and reliable dosing, ensuring that the correct amount of chemical treatment is delivered into the water. This allows for effective and efficient treatment of the water, minimizing the risk of unintended consequences or inadequate treatment.

### Example 1: Underwater Pressure Dispensing of Product Within a Vessel

An underwater vessel as depicted in FIGS. 9, 10 and 11 with air headspace inside the vessel was filled with a dark blue dye that serves as a dilution indicator for the product in the vessel, and as the pressure fluctuates throughout the level of the vessel in the body of water and equalizes, the vessel pulls in outside water, which dilutes the content of the vessel thus changing the colour of the contents indicating a loss in concentration.

The vessel was tethered to a submersible cleaning robot using translucent fishing line. The submersible cleaning robot cleans both the floor and wall surfaces of a swimming pool by traveling across the floor and up and down the walls multiple times with the vessel attached to the submersible cleaning robot. The up and down movement allowed for pressure changes to occur multiple times per hour, dispensing product into the pool water.

The vessel was tethered in a way that maintained the air headspace at the top of the vessel, preventing inversion of the air space and ensuring consistent operation.

The vessel was visibly dispensing product as it rose off the bottom of the pool. The internal product, initially dark blue, was contrasted with the pool water as it was being dispensed at the top of the water and became visible.

After 24 hours inside the pool and at least two cleaning cycles from the submersible cleaning robot, the internal liquid within the vessel had turned from a dark blue to a light blue. This colour change indicated that the product was being dispensed into the pool and ultimately diluted within the vessel due to the fluctuations in pressure from traveling up and down the pool walls from the water surface (see FIG. 9) to 5 feet below (see FIG. 10) the water surface to 10 feet (see FIG. 11) below the water surface and the dispensing of internal contents into the pool when the pressure inside the vessel was greater than the external pressure as well as receiving water from the pool when the pressure inside the vessel was less than the external pressure.

The liquid level and air headspace level inside the vessel remained the same after 24 hours as when it was initially placed into the pool. Although not wanting to be limited by theory, it is possible that temperature variations at the surface and bottom of the pool may have played a role in the dispensing of product into the pool as well.

### Example 2: Use of a Chemical Reaction to Increase Internal Pressure in a Vessel

A vessel was filled with water while leaving a head space atop the vessel. A bath bomb comprising sodium bicarbonate and citric acid was added to the water in the vessel and a threaded cap with a two-way valve was secured onto the device. The vessel was then placed below a swimming pool surface requiring treatment. As the sodium bicarbonate and citric acid reacted with the water inside the vessel, sodium citrate and carbon dioxide gas are produced increasing the internal pressure within the vessel causing a jet of liquid/gas released from the two-way valve in the forcing product out through the two-way valve.

In one alternative, when a focused cleaning or treatment is required, an elevated pressure over a period of time in the vessel to dose/treat a water pool problem while attached to a cleaning pole or robotic cleaner, the implementation of a gas producing reaction within the vessel will increase the internal pressure in the vessel and cause the contents of the vessel to be released into the pool while the water pool surface is being agitated and/or scrubbed by a brush or roller to remove a stain or algae from a water pool surface.

The present disclosure has several advantages over conventional devices such as:
Precision dosing: The device provides accurate and reliable dosing, ensuring that the correct amount of chemical treatment is delivered into the water.
Refillability: The device can be refilled with the desired content, reducing waste and minimizing environmental impact.
Floatability: The device's buoyant nature allows it to remain afloat on the surface of the water, making it easy to deploy and retrieve.
Temperature and pressure actuation: The device is designed to respond to changes in temperature and pressure, ensuring that the chemical treatment is effectively dispersed and utilized by the water.
Child-resistant closure to mitigate child tampering.
Submersibility: The device, in one alternative, may be submersible and be connected/secured to an existing cleaning device such that when the cleaning device is placed into the body of water, the submersible version will be actuated to release the desired content by the hydrostatic pressure exerted on the flexible vessel wall.

1. A refillable buoyant dispensing device for measurably dispensing liquid chemical treatment into a body of water, comprising:
a vessel having a wall and a vessel opening at one end and a vessel surface at a opposite end of said vessel;
said vessel opening for receiving a liquid into said vessel;
a removable closure for closing said vessel opening, a metered dosing device in communication with said vessel opening and said removable closure, for metered dose dispensing of said liquid chemical treatment into said body of water;
wherein in use, said metered dosing device remains below a surface level of said body of water;
wherein in use, said vessel contains a predetermined amount of liquid chemical treatment, in communication with said metered dosing device, and a predetermined amount of gaseous head space, wherein in use said predetermined amount of gaseous head space is above said predetermined amount of liquid chemical;
wherein said wall further comprises a heat transfer area allowing for transfer of heat from an exterior of said vessel to an interior of said vessel when ambient temperature outside said vessel is greater than temperature of said interior of said vessel;
wherein when said interior of said vessel has a temperature increase, said gaseous head space increases in volume and pressure causing a metered dose of said liquid chemical to be released into said body of water;
wherein when said interior of said vessel has a temperature decrease, said gaseous head space decreases in volume and pressure causing water from said body of water to enter said vessel.

2. The refillable buoyant dispensing device of claim 1, further comprising at least one of a liquid chemical concentration indicator, a liquid chemical volume indicator, and combinations thereof.

3. The refillable buoyant dispensing device of claim 1, wherein said removable closure further comprises a tamper-proof locking mechanism for locking said removable closure to said vessel opening.

4. The refillable buoyant dispensing device of claim 1, wherein said metered dosing device comprises a two-way valve, wherein said two-way valve comprises an outflow channel for dispensing the liquid chemical treatment during an increase in internal temperature of said vessel and an inflow channel for drawing in water during a decrease in internal temperature of said vessel.

5. The refillable buoyant dispensing device of claim 1, further comprising at least one of a pressure sensor monitoring internal pressure of the vessel, a temperature sensor monitoring internal temperature of the vessel, and combinations thereof.

6. The refillable buoyant dispensing device of claim 5, wherein said pressure sensor sends a signal to an external control unit to adjust a dispensing rate of the liquid chemical treatment based on changes in internal pressure of said vessel, and wherein said temperature sensor sends a signal to an external control unit to adjust a dispensing rate of the liquid chemical treatment based on changes in internal temperature of said vessel.

7. The refillable buoyant dispensing device of claim 1, wherein said vessel is blow-moulded or injection-moulded of a material selected from the group consisting of ultra-violet (UV) enhanced high density polyethylene (HDPE) plastic, UV enhanced polypropylene plastic and combinations thereof.

8. The refillable buoyant dispensing device of claim 1, wherein said vessel further comprises a flattened surface for keeping said vessel stationary while filling said vessel.

9. The refillable buoyant dispensing device of claim 1, wherein the gaseous head space creates positive/negative pressure determined by 10° C. ambient temperature variation, allowing for consistent dispensing of the liquid chemical treatment into the body of water.

10. A method of treating a body of water using a refillable buoyant dispensing device of claim 1, comprising:
placing the refillable buoyant dispensing device filled with a liquid chemical treatment on a surface of a body of water;
and allowing the refillable buoyant dispensing device to dispense liquid chemical treatment based on internal air temperature changes.

11. A refillable dispensing device for measurably dispensing liquid chemical treatment into a body of water, comprising:
a vessel having a flexible wall and a vessel opening at one end and a vessel surface at a opposite end of said vessel;
said vessel opening for receiving a liquid into said vessel;
a removable closure for closing said vessel opening, a metered dosing device in communication with said vessel opening and said removable closure, for metered dose dispensing of said liquid chemical treatment into said body of water;
wherein in use, said refillable dispensing device remains below a surface level of said body of water;
wherein in use, said flexible vessel contains a predetermined amount of liquid chemical treatment, in communication with said metered dosing device, wherein in use when under a surface of said body of water, hydrostatic pressure of said body of water acts upon the flexible vessel causing a predetermined amount of liquid chemical to pass through the metered dosing device into said body of water;
wherein when said vessel moves up the body of water, the hydrostatic pressure is reduced on the vessel causing water from said body of water to enter said vessel.

12. The refillable dispensing device of claim 1, further comprising a gas producing element within the device for increasing internal pressure of the device.

13. The refillable dispensing device of claim 1, wherein the vessel comprises two vessels matingly attached to each other, each of said two vessels having a vessel opening, wherein each vessel opening is adjacent to each other, wherein each of said two vessels contains a liquid selected from the group consisting of: i) different from each other; ii) same as each other.

14. The refillable dispensing device of claim 13, wherein each of the two vessels are matingly attached to each other via at least one of the following:
a. a friction fit;
b. each of said two vessels comprise a male portion and a female portion, wherein the male portion of one of said two vessels fits in the female portion of the other of said two vessels and the male portion of the other of said two vessels fits in the female portion of the one of said two vessels;
c. a two vessel locking collar; and combinations thereof.

15. The refillable dispensing device of claim 13 wherein each of said two vessels have a metered dosing device.

16. The refillable dispensing device of claim 13, wherein the two-vessel locking collar is proximate the vessel opening.

17. The refillable dispensing device of any one of claim 1 further comprising a detachable media dispenser attached to an outside surface of said vessel, said detachable media dispenser comprising:
a. a body having a closed end and an open end; said closed end having at least one connector for connecting to said outside surface of said vessel;
b. a cap for matingly engagement with said open end of said body;
c. said body further comprises a containment area for containing said media;
wherein said body further comprises at least one opening along a side thereof for water and media passage from the containment area to the body of water and from the body of water to the containment area; wherein said cap further comprises at least one opening along a side thereof for water and media passage from the containment area to the body of water and from the body of water to the containment area; wherein said cap is adjustable from a first position to a second position, wherein in a first position the at least one opening of said body is in alignment with the at least one opening of said cap, to a second position wherein the at least one opening of said body is not in alignment with the at least one opening of said cap, regulating the flow of water and media from the containment area to the body of water and from the body of water to the containment area; wherein said at least one connector for connecting to said outside surface of said vessel connects said detachable media dispenser such that the closed end of the body of the detachable media dispenser is distant said metered dosing device allowing for access to the removable closure without the need to detach the detachable media dispenser from the vessel.

18. The refillable dispensing device of claim 17 wherein said media comprises one or more water treatment agents selected from the group consisting of halogen-based sanitizers (including but not limited to chlorine and bromine), pH adjusters (including sodium carbonate, sodium bicarbonate, sodium bisulfate), hardness increasers (such as calcium chloride), stabilizers (such as cyanuric acid), alkalinity increasers, oxidizers (including calcium hypochlorite and dipotassium monopersulfate), flocculants, scale inhibitors, enzymes, phosphate removers, mineral-based sanitizers (including silver and copper ions), algaecides, clarifiers, stain and scale preventatives, sequestering agents, surfactant blends, specialty seasonal formulations (including but not limited to winterizing or startup blends), fragrance compounds, water softening agents, biological control agents, effervescent agents, dispersing agents, lanthanum, lanthanide, aluminum, alum, borates, activated carbon, and combination thereof.

19. The refillable dispensing device of claim 17 wherein said media is in the form of a solid, liquid, powder, compressed tablet, granule, encapsulated media including a dissolving pouch, and combinations thereof suitable for controlled erosion or dissolution within the dispensing device.

20. The refillable dispensing device of claim 17, wherein said detachable media dispenser comprises a plurality of spaced-apart connectors.

21. The refillable dispensing device of claim 17, wherein the body comprises a plurality of spaced-apart openings along said side, and said cap comprises a plurality of spaced-apart openings along said side.

22. The refillable dispensing device of claim 1 wherein said device is made from a material selected from an ultra-violet (UV) activated colour changing resin such that when indoors, each of said liquid chemical concentration indicator and said liquid chemical volume indicator is visible indoors when refilling the device, and not visible outdoors and when in water.

23. A method of treating a body of water using the refillable buoyant dispenser of claim 13, said method comprising:
a. placing the refillable buoyant dispensing device filled with a liquid chemical treatment on a surface of a body of water; and
b. allowing the refillable buoyant dispensing device to dispense into said body of water liquid chemical treatment based on internal air temperature changes.

24. A method of treating a body of water using the refillable buoyant dispenser of claim 17, said method comprising:
a. placing the refillable buoyant dispensing device filled with a liquid chemical treatment and detachable media dispenser filled with a media on a surface of a body of water; and
b. allowing the refillable buoyant dispensing device and detachable media dispenser to dispense into said body of water liquid chemical treatment from the refillable buoyant dispensing device based on internal air temperature changes and media from the detachable media dispenser based on dissolution.

25. The refillable dispensing device of claim 11, further comprising a gas producing element within the device for increasing internal pressure of the device.
